(19) United States
(12) Patent Application Publication
(10) Pub. No.: US 2012/0299752 A1
(43) Pub. Date: Nov. 29, 2012

(54) Air & Ground Surveillance Application for Portable Devices

(76) Inventors: Mohamed R. Mahmoud, Daytona Beach, FL (US); Johnathan J. Pesce, Ormond Beach, FL (US)

(21) Appl. No.: 13/479,621

(22) Filed: May 24, 2012

Related U.S. Application Data
(60) Provisional application No. 61/491,049, filed on May 27, 2011.

(51) Int. Cl. G01C 21/00

(52) U.S. Cl. 340/972; 340/971

(57) ABSTRACT

A method, system, and computer readable medium are provided for displaying air and ground surveillance information on a portable electronic device. The receipt of a plurality of surveillance messages is enabled for both air and ground vehicles on the portable electronic device. The portable electronic device is connected by a wireless connection to a surveillance server. A plurality of surveillance messages are received by the portable electronic device after establishing a communication link with the surveillance server. Surveillance information is extracted from the plurality of surveillance messages by the portable electronic device. The surveillance information is rendered on a display of the portable electronic device.

### CROSS-REFERENCE TO RELATED APPLICATION

This application claims the benefit of U.S. Provisional Patent Application Ser. No. 61/491,049, filed on May 27, 2011. The specification and drawings of the provisional patent application are specifically incorporated by reference herein.

### TECHNICAL FIELD

Embodiments of the invention generally relate to portable electronic devices such as smartphones and tablets and, more specifically, to a method and system for displaying real-time or near real-time air and ground surveillance information on portable electronic devices.

### BACKGROUND OF THE INVENTION

Portable electronic devices such as smartphones and tablets are versatile multi-functional devices that can support a variety of applications and store significant amounts of data in the form of documents, media, and files in various formats. Such devices typically support a web browser, a portable media player, an email client, a document editor, and a global positioning system (GPS) receiver for providing location and tracking information. Examples of such portable electronic devices include the Apple iPhone, Android-based smartphones, Blackberry smartphones, Apple iPad tablets, Android-based tablets, and Blackberry PlayBook tablets. A large number of applications have been developed for each of the smartphones and tablets and the different manufacturers have established online application stores for their users to select, purchase, and download software applications for such portable electronic devices. In the following description, “portable electronic device” will be used to refer generally to all portable electronic devices having communications and messaging functionality.

GPS provides highly accurate location results for a portable device in open environments. A Wi-Fi-based Positioning System (WPS) determines the location of a portable device based on a database of known wireless access points which are typically wireless routers having a unique identifier (i.e., MAC address). WPS has no line of sight requirements and is accurate to within 20 meters. WPS provides services similar to GPS without GPS-hardware and can be integrated with GPS-enabled devices to provide hybrid positioning. Cell tower triangulation provides generalized location results but with only 200-1000 meter accuracy. Hybrid systems can include a combination of WPS, GPS, and cell triangulation to locate portable devices.

Automatic Dependent Surveillance-Broadcast (ADS-B) is a surveillance technology for tracking aircraft as part of the Next Generation Air Transportation System and will be required for the majority of aircraft operating in the United States by the start of the next decade. ADS-B periodically broadcasts its own state vector (i.e., identification, altitude, heading, speed, position) and other information without knowing what other vehicles or entities may be receiving it. No pilot or controller action is required for the information to be issued. Surveillance information is dependent on the navigation and broadcast capability in the source ADS-B equipped aircraft. The use of the Global Positioning System (GPS) as the primary onboard navigation data source was developed through national and international standards organizations in the 1990s.

When using ADS-B, pilots and controllers will both see the same surveillance picture. With prior art systems such as Traffic Collision Avoidance System (TCAS), aircraft could only see other similarly equipped aircraft. Using ADS-B, the vehicle can receive position data from similarly equipped aircraft and ground vehicles. Using TIS-B allows the display of vehicles that are not similarly equipped that are tracked by the ground system via radar, ADS-B, or any other mechanism.

The Federal Aviation Administration has approved two data links for the ADS-B system in the U.S. Universal Access Transceiver (UAT) has been approved for the general aviation community. 1090 MHz Mode S Extended Squitter (ES) has been approved for air carrier and private/commercial operators of high performance aircraft.

Traffic Information Services-Broadcast (TIS-B) supplements ADS-B to provide complete situational awareness in the cockpit of all traffic known to the air traffic control system. A ground TIS-B station transmits surveillance target information from a ground radar system on an ADS-B data link to aircraft not equipped with ADS-B or aircraft transmitting on the other ADS-B data link.

### SUMMARY

Embodiments of the invention provide a portable multifunction device having a Geographical Information System (GIS)-based application capable of displaying geospatial referenced data on an Electronic Multi-Information Display (EMID) operating on the portable multifunction device. The application supports pan and zoom and allows the user to turn data layers on and off. EMID is capable of displaying high fidelity Environmental Systems Research Institute, Inc. (ESRI) shape files of airspace volumes and aircraft layouts for precise tracking of aircraft taxiing. EMID also displays real-time or near real-time aircraft and ground vehicle surveillance information such as ADS-B and TIS-B aircraft/vehicle position data.

The real-time or near real-time surveillance information received by the device is rendered on a geographical map display to represent current position and the current device position. The rendered surveillance information is presented in a way that corresponds to the type of the aircraft or ground vehicle such that the vehicle is shown with a symbol that represents its type. The color of the rendered surveillance information can be set according to user input settings. Additional information can be obtained through a single device tap close to the rendered surveillance information. An extended data block will be displayed showing additional information configurable by the user such as speed, heading, and latitude/longitude. Additionally, the EMID air and ground surveillance application on the portable multifunction device can be used to transmit its precise location to a remote surveillance server in real-time.

In an exemplary embodiment, a method, system, and computer readable medium are provided for displaying air and ground surveillance information on a portable electronic device. The receipt of a plurality of surveillance messages is enabled for both air and ground vehicles on the portable electronic device. The portable electronic device is connected by a wireless connection to a surveillance server. A plurality of surveillance messages are received by the portable electronic device after establishing a communication link with the surveillance server. Surveillance information is extracted from the plurality of surveillance messages by the portable electronic device. The surveillance information is then rendered on a display of the portable electronic device.

### BRIEF DESCRIPTION OF THE DRAWINGS

These and other advantages and aspects of the embodiments of the disclosure will become apparent and more readily appreciated from the following detailed description of the embodiments taken in conjunction with the accompanying drawings, as follows.

FIG. 1 illustrates a networking environment in which embodiments of the invention can be enabled.

FIG. 2 illustrates a touch-sensitive user interface for a real-time or near real-time ground surveillance display on a portable multifunction device when the application is enabled in an exemplary embodiment.

FIG. 3 illustrates processing logic for the air and ground surveillance application for portable multifunction devices in an exemplary embodiment.

FIG. 4 illustrates a touch-sensitive user interface for the air and ground surveillance application installed on a portable multifunction device.

FIG. 5 illustrates a touch-sensitive user interface for a real-time or near real-time air surveillance display on a portable multifunction device when the application is enabled in an exemplary embodiment.

### DETAILED DESCRIPTION

The following description is provided as an enabling teaching of embodiments of the invention including the best, currently known embodiment. Those skilled in the relevant art will recognize that many changes can be made to the embodiments described, while still obtaining the beneficial results. It will also be apparent that some of the desired benefits of the embodiments described can be obtained by selecting some of the features of the embodiments without utilizing other features. Accordingly, those who work in the art will recognize that many modifications and adaptations to the embodiments described are possible and may even be desirable in certain circumstances. Thus, the following description is provided as illustrative of the principles of the invention and not in limitation thereof, since the scope of the invention is defined by the claims.

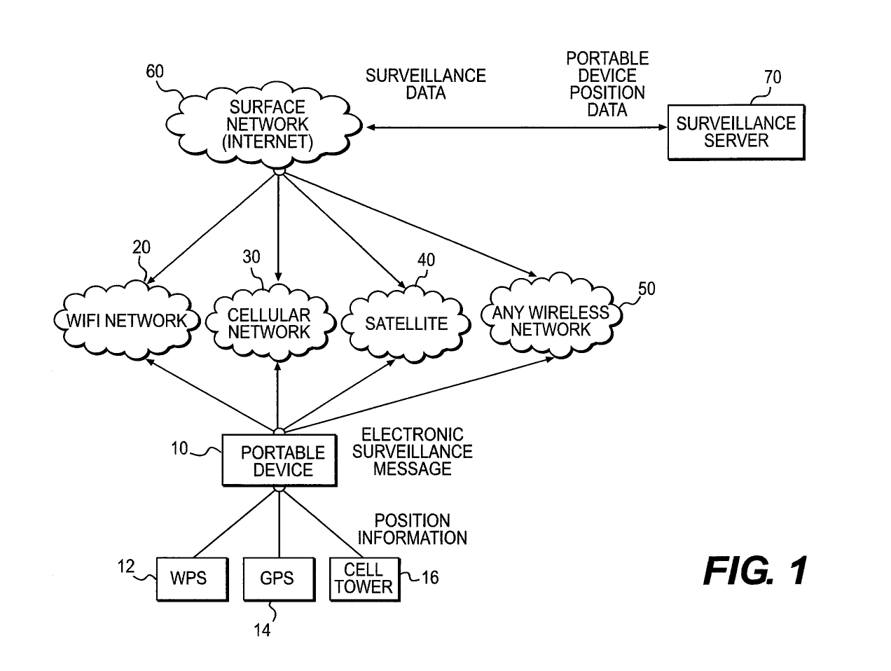

In the following description, the terms “portable multifunction device” refer to a portable electronic device having the Electronic Multi-Information Display (EMID) air and ground surveillance application installed and operating. The EMID air and ground surveillance application is a ground-passed application that can display surveillance information for both ground and air vehicles. In an exemplary embodiment, the ADS-B/TIS-B data is received from aircraft by ground-based transceivers that push the data to a surveillance server. The EMID air and ground surveillance application connects to the surveillance server via one of the media 20, 30, 40, 50 shown in FIG. 1 using TCP or UDP protocol. Once connected, the application sends login information for authentication with the server before the server starts pushing the surveillance information to the client. The surveillance information received from the surveillance server includes location information such as latitude/longitude along with other information pertinent to the aircraft and ground vehicle such as vehicle identification. The surveillance information is then processed by the EMID air and ground surveillance application to extract the required information for rendering on the EMID display. The portable multifunction device that runs the EMID application can be installed in ground vehicles and can extract its location information from several sources as illustrated in FIG. 1 and discussed below. If the EMID application installed in the ground vehicle is enabled, it will transmit its location information to the surveillance server.

FIG. 1 illustrates a networking environment in which embodiments of the invention can be enabled. Portable multifunction device position information can be provided by Wi-Fi-based Positioning System (WPS) 12, Global Positioning System (GPS) 14, and cell tower 16. Electronic surveillance messages from portable multifunction device 10 can be transmitted over Wi-Fi network 20, cellular network 30, satellite 40, or any wireless network 50. The electronic surveillance messages are then transmitted over the Internet 60 to a surveillance server 70. Surveillance information is also transmitted from the surveillance server to the portable multifunction device via Wi-Fi network 20, cellular network 30, satellite 40, or wireless network 50.

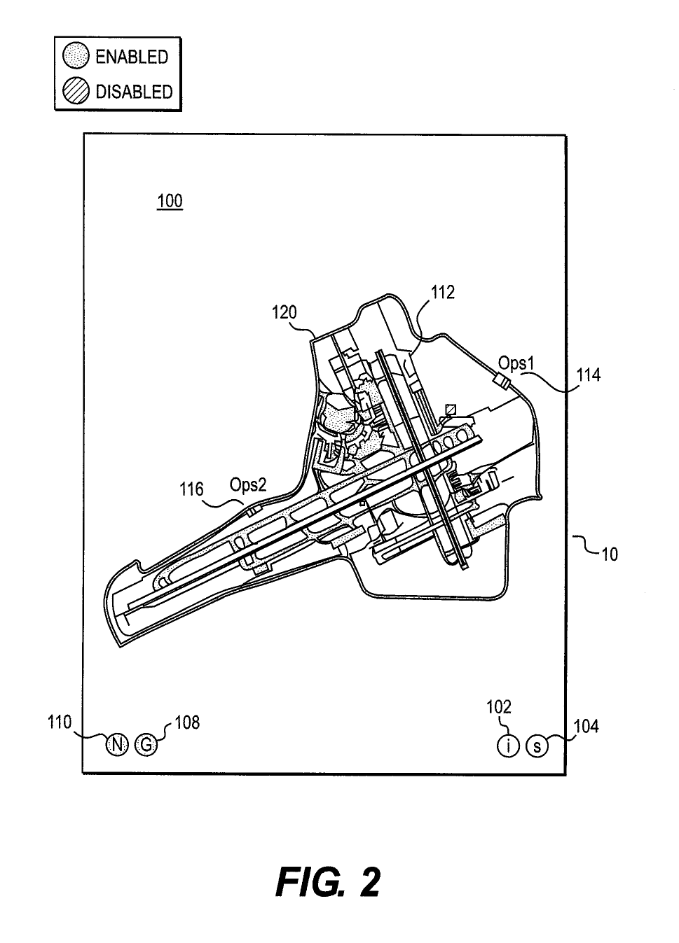

FIG. 2 illustrates a ground surveillance display 100 on a touch-sensitive user interface (i.e., “touch screen”) for a portable multifunction device 10 when the EMID air and ground surveillance application is enabled in an exemplary embodiment. The EMID display 100 is a GIS (Geographical Information System) based application capable of displaying detailed geographical map data on the display including airport layout. The EMID display 100 shows the current network status as well as location monitoring status 108 if location monitoring is enabled. The EMID display 100 shows a real-time or near real-time airport-based environment including airport runway/taxiway layout map 120, network connection status indicator 110, location monitoring status indicator 108, application information button 102, and application settings button 104. The layout map 120 on the EMID display 100 shows the airport runways and taxiways as well as the position of aircraft (with data block) 112 and ground vehicles (with data block) 114, 116. An extended data block 120 can be obtained and displayed through a single device tap close to the displayed location of the aircraft showing additional information configurable by the user such as speed, heading, and latitude/longitude.

The airport runway/taxiway layout map can be loaded on the portable multifunction device 10 in several ways, for example, from an airport database system that could be installed with the EMID application. Alternatively, the EMID application could download the airport runway/taxiway layout map based on the location of the portable multifunction device.

The selectable application information button 102 and application settings button 104 have associated user interface displays depicting information regarding the EMID application and EMID application settings, respectively.

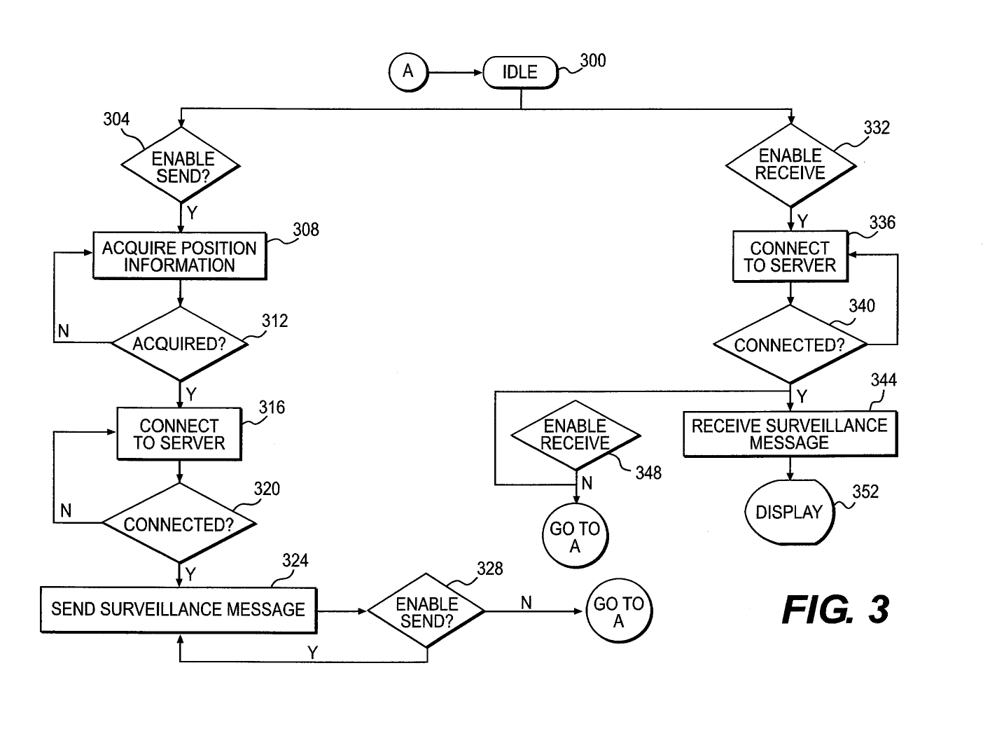

FIG. 3 illustrates processing logic for the EMID air and ground surveillance application for portable multifunction devices in an exemplary embodiment. The portable multifunction device remains in an idle state as indicated in step 300 until an “enable send” surveillance message function or an “enable receive” surveillance message function is activated by the EMID air and ground surveillance application as indicated in step 304 and 332, respectively. If the “enable send” function is activated in step 304, the portable multifunction device EMID air and ground surveillance application will acquire position information in step 308. The portable multifunction device will remain in this state until its position is acquired as indicated in step 312. Once position information is acquired, the portable multifunction device EMID application will attempt to connect to the surveillance server in step 316. The portable multifunction device will remain in this state until surveillance server connection is acquired as indicated in step 312. Once connection to the surveillance server is acquired in step 320, the portable multifunction device air and ground surveillance application will send a surveillance message as indicated in step 324. The portable multifunction device air and ground surveillance application will remain in the enable send state in step 328 and continue to transmit surveillance messages until the enable send function is deactivated. When deactivated, the portable multifunction device will return to idle state 300.

If the “enable receive” function is activated in step 332, the portable multifunction device EMID application will attempt to connect to the surveillance server in step 336. The portable multifunction device will remain in this state until surveillance server connection is acquired as indicated in step 340. Once connection to the surveillance server is acquired in step 340, the portable multifunction device air and ground surveillance application will receive surveillance messages as indicated in step 344 and will display the surveillance messages in step 352. The portable multifunction device air and ground surveillance application will then determine if the enable receive function is still activated in step 348. If the function is still activated, the portable multifunction device air and ground surveillance application will continue to receive and display surveillance messages until a determination is made that the enable receive function has been deactivated. When the enable receive function is deactivated, the portable multifunction device will return to idle state 300.

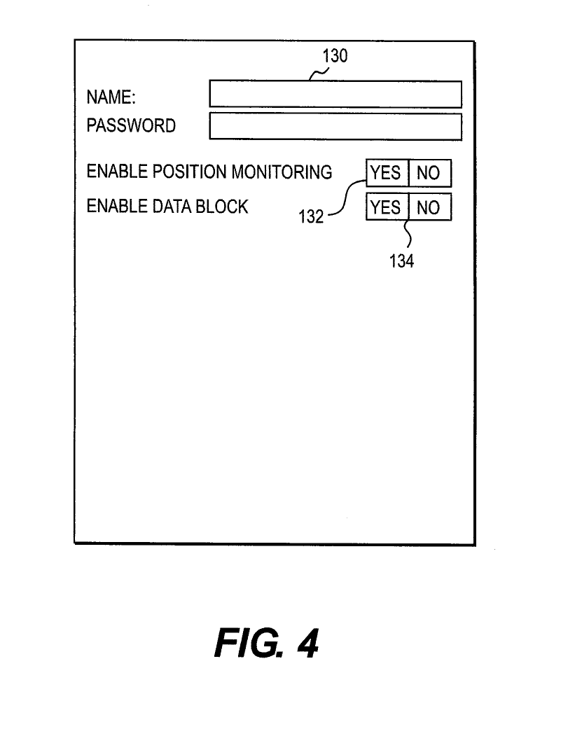

FIG. 4 illustrates a touch-sensitive user interface for the portable multifunction device EMID air and ground surveillance application. The user enters credentials (e.g., username and password) into the login block 130, selects whether to enable or disable position monitoring with buttons 132, and selects whether to enable or disable showing vehicle identification with buttons 134.

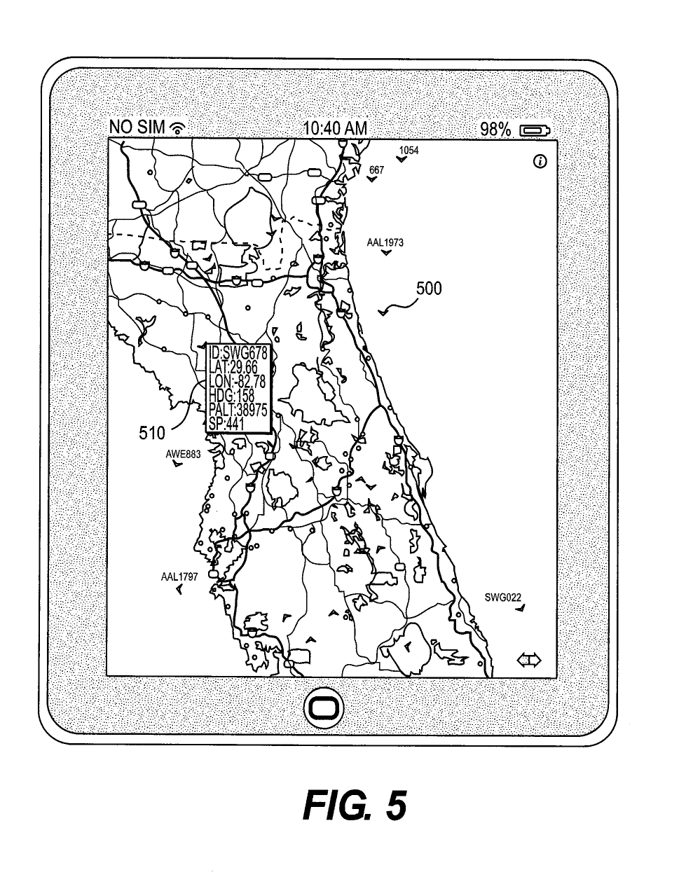

FIG. 5 illustrates a real-time or near real-time air surveillance display 100 on a touch-sensitive user interface (i.e., “touch screen”) for a portable multifunction device 10 when the EMID air and ground surveillance application is enabled in an exemplary embodiment. In this embodiment, a user is enabled to access the data feeds for certain ADS-B equipped flights in the vicinity of certain airfields (i.e., in the surrounding airspace). Commercial and general aviation flights that are being conducted in the vicinity of these airfields and that are ADS-B equipped will appear on top of a map display. The source of the map display can be any readily available map display including, but not limited to, Google maps. The positions and headings of the aircraft will be adjusted continuously since the data is continuously updated. The commercial flights can be designated with a color-coded arrow 500 (e.g., blue arrow for commercial aviation flights, green arrow for general aviation flights) and flight call sign. In order to obtain additional information about a displayed flight in the form of a data block on the display, the user can tap on the flight designation to bring up the flight's current call sign, position (latitude, longitude), heading, altitude, speed, and any other relevant information.

Embodiments of the invention have been described as computer-implemented processes. It is important to note, however, that those skilled in the art will appreciate that the mechanisms of the embodiments described are capable of being distributed as a program product in a variety of forms, and that the invention applies regardless of the particular type of computer readable medium utilized to carry out the distribution.

The corresponding structures, materials, acts, and equivalents of all means plus function elements in any claims below are intended to include any structure, material, or acts for performing the function in combination with other claim elements as specifically claimed. Those skilled in the art will appreciate that many modifications to the exemplary embodiments are possible without departing from the scope of the present invention.

In addition, it is possible to use some of the features of the embodiments disclosed without the corresponding use of the other features. Accordingly, the foregoing description of the exemplary embodiments is provided for the purpose of illustrating the principles of the invention, and not in limitation thereof, since the scope of the invention is defined solely by the appended claims.

What is claimed:

1. A method for displaying air and ground surveillance information on a portable electronic device comprising:
enabling receipt of a plurality of surveillance messages for aircraft and ground vehicles on the portable electronic device;
connecting the portable electronic device by a wireless connection to a surveillance server;
receiving the plurality of surveillance messages by the portable electronic device after establishing a communication link with the surveillance server; and
extracting surveillance information from the plurality of surveillance messages by the portable electronic device; and
rendering the extracted surveillance information on a display of the portable electronic device.

2. The method for displaying air and ground surveillance information of claim 1 further comprising receiving real-time or near real-time data from at least one aircraft by a ground-based transceiver and pushing the aircraft data to the surveillance server.

3. The method for displaying air and ground surveillance information of claim 2 wherein the aircraft data comprises at least one of Automatic Dependent Surveillance-Broadcast (ADS-B) or Traffic Information Services-Broadcast (TIS-B) data.

4. The method for displaying air and ground surveillance information of claim 1 further comprising enabling sending of a plurality of surveillance messages from the portable electronic device.

5. The method for displaying air and ground surveillance information of claim 4 further comprising acquiring position data by the portable electronic device and sending a surveillance message including the position data to the surveillance server.

6. The method for displaying air and ground surveillance information of claim 5 wherein the position data is provided by at least one of a wireless fidelity positioning system, a global positioning system, and a cellular network.

7. The method for displaying air and ground surveillance information of claim 1 wherein rendering the surveillance information on the display comprises loading a layout map of an airport's runways and taxiways and locating a position of each aircraft and ground vehicle relative to the layout map.

8. The method for displaying air and ground surveillance information of claim 7 wherein loading of the layout map is based on a geographical location of the portable electronic display.

9. The method for displaying air and ground surveillance information of claim 1 wherein rendering the surveillance information on the display comprises loading a map of a geographical area corresponding to an airspace and locating a position of each aircraft relative to the geographical map.

10. A system for displaying air and ground surveillance information on a portable electronic device comprising:
a processor for executing a plurality of components, including:
a component for enabling receipt of a plurality of surveillance messages for aircraft and ground vehicles on the portable electronic device;
a component for connecting the portable electronic device by a wireless connection to a surveillance server;
a component for receiving the plurality of surveillance messages by the portable electronic device after establishing a communication link with the surveillance server;
a component for extracting surveillance information from the plurality of surveillance messages; and
a component for rendering the extracted surveillance information on a display of the portable electronic device.

11. The system for displaying air and ground surveillance information of claim 10 further comprising a component for receiving real-time or near real-time data from at least one aircraft by a ground-based transceiver and pushing the aircraft data to the surveillance server.

12. The system for displaying air and ground surveillance information of claim 11 wherein the aircraft data comprises at least one of Automatic Dependent Surveillance-Broadcast (ADS-B) and Traffic Information Services-Broadcast (TIS-B) data.

13. The system for displaying air and ground surveillance information of claim 10 further comprising a component for enabling sending of a plurality of surveillance messages from the portable electronic device.

14. The system for displaying air and ground surveillance information of claim 13 further comprising a component for acquiring position data by the portable electronic device and sending a surveillance message including position data to the surveillance server.

15. The system for displaying air and ground surveillance information of claim 14 wherein the position data is provided by at least one of a wireless fidelity positioning system, a global positioning system, and a cellular network.

16. The system for displaying air and ground surveillance information of claim 10 wherein the component for rendering the plurality of surveillance messages on the display comprises a module for loading a layout map of an airport's runways and taxiways and locating a position of each aircraft and ground vehicle relative to the layout map.

17. The system for displaying air and ground surveillance information of claim 16 wherein the layout map is based on a geographical location of the portable electronic display.

18. The system for displaying air and ground surveillance information of claim 10 wherein the component for rendering the plurality of surveillance messages on the display comprises a module for loading a map of a geographical area corresponding to an airspace and locating a position of each aircraft relative to the geographical map.

19. A non-transitory computer readable medium for displaying air and ground surveillance information on a portable electronic device when executed by a computer processor, the computer readable medium comprising:
program instructions for enabling receiving a plurality of surveillance messages for aircraft and ground vehicles on the portable electronic device;
program instructions for connecting the portable electronic device by a wireless connection to a surveillance server;
program instructions for receiving the plurality of surveillance messages after establishing a communication link with the surveillance server; and
program instructions for extracting surveillance information from the plurality of surveillance messages; and
program instructions for rendering the extracted surveillance information on a display of the portable electronic device.

20. The computer readable medium for displaying air and ground surveillance information of claim 19 wherein the computer readable medium further comprises program instructions for receiving real-time or near real-time data from at least one aircraft by a ground-based transceiver and pushing the aircraft data to the surveillance server.

21. The computer readable medium for displaying air and ground surveillance information of claim 20 wherein the aircraft data comprises at least one of Automatic Dependent Surveillance-Broadcast (ADS-B) and Traffic Information Services-Broadcast (TIS-B) data.

22. The computer readable medium for displaying air and ground surveillance information of claim 19 wherein the computer readable medium further comprises program instructions for enabling sending of a plurality of surveillance messages from the portable electronic device.

23. The computer readable medium for displaying air and ground surveillance information of claim 19 wherein the computer readable medium further comprises program instructions for acquiring position data and sending a surveillance message including position data to the surveillance server.

24. The computer readable medium for displaying air and ground surveillance information of claim 23 wherein the position data is provided by at least one of a wireless fidelity positioning system, a global positioning system, and a cellular network.

25. The computer readable medium for displaying air and ground surveillance information of claim 19 wherein the program instructions for rendering the surveillance information on the display comprise program instructions for loading a layout map of an airport's runways and taxiways and locating a position of each aircraft and ground vehicle relative to the layout map.

26. The computer readable medium for displaying air and ground surveillance information of claim 25 wherein the program instructions for loading the layout map are based on determination of a geographical location of the portable electronic display.

27. The computer readable medium for displaying air and ground surveillance information of claim 19 wherein the program instructions for rendering surveillance information on the display comprise program instructions for loading a map of a geographical area corresponding to an airspace and locating a position of each aircraft relative to the geographical map.
